(19) United States
(12) Patent Application Publication
(10) Pub. No.: US 2006/0271714 A1
(43) Pub. Date: Nov. 30, 2006

(54) DATA RETRIEVING METHODS

(75) Inventors: Yao-Chun Su, Taipei (TW); Wei-Lin Wang, Taipei (TW); Rui-Zhao Li, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/382,331

(22) Filed: May 9, 2006

(30) Foreign Application Priority Data
May 27, 2005 (TW) 94117501

(51) Int. Cl. G06F 13/42

(52) U.S. Cl. 710/106

(57) ABSTRACT

Data retrieving method applied for a computer system compliant with PCI-Express protocol. The computer has a PCI-Express bus coupled to an endpoint. In the method, a data is retrieved in response to a read request. In then invention, the data is composed by a plurality of data section, and data length of each data section is a default data length defined by the PCI-Express specification. Then, a plurality of response packets are transferred to an objective endpoint, wherein each response packet is formed by the plurality of data sections with a variable data length.

### BACKGROUND OF THE INVENTION

1. Field of the Invention

The invention relates to data mergence, and in particular to a data retrieving method capable of preventing redundant headers and improving bus transfer efficiency.

2. Description of the Related Art

Many methods are used to transfer data in a computer system or between computer systems, and in some, data is packaged and transferred as a packet. For instance, peripheral component interconnect express (PCI-Express) protocol packages data and transfer packages, although package transfer causes overhead no matter what protocol is used.

For example, some types of packages require headers to record information comprising content and/or requestor ID relative to the packet. In the case of PCI-Express, a read request from the PCI-Express endpoint is used to generate a plurality of 8QW or 4QW alignment transactions to snoop a CPU and/or read a system memory. Each data section returned from the CPU or the system memory is packaged into a return transaction layer packet, such as packets PKT1˜PKTN as shown in FIG. 1, and transferred to the PCI-Express endpoint through data link layer and physical layer. This method, however, causes many redundant headers, such as H1˜HN, and thus, non-posted round-trip latency is increased and bus transfer efficiency is degraded.

### BRIEF SUMMARY OF THE INVENTION

A data retrieving method for a computer system compliant with PCI-Express protocol, in which the computer has a PCI-Express bus coupled to an endpoint, comprising: retrieving a data in response to a read request from the endpoint. The data is composed by a plurality of data section, and data length of each data section is a default data length defined by the PCI-Express specification. Then, a plurality of response packets are transferred to an objective endpoint, wherein each response packet is formed by the plurality of data sections with a variable data length, wherein each response packet is a TLP with a herder and data content therein.

The invention also provides a machine-readable storage medium having a computer program, which, when executed, directs a computer system to perform a data retrieving method. In the method, a data, composed by a plurality of data section, in response to a read request is retrieved. The data length of each data section is a default data length defined by the PCI-Express specification. Then, a plurality of response packets are transferred to an objective endpoint. In the invention, each response packet is formed by the plurality of data sections with a variable data length, and each response packet is a TLP with a herder and data content therein.

The invention also provides a computer system compliant with PCI-Express protocol, in which an endpoint is coupled to a PCI-Express bus, and a bridge unit is coupled to the endpoint through the PCI-Express bus, retrieving a data in response to a read request from the endpoint. The data is composed by a plurality of data section, and data length of each data section is a default data length defined by the PCI-Express specification. Then, a plurality of response packets are transferred to an objective endpoint, wherein each response packet is formed by the plurality of data sections with a variable data length, wherein each response packet is a TLP with a herder and data content therein.

### BRIEF DESCRIPTION OF THE DRAWINGS

The invention can be more fully understood by reading: the subsequent detailed description and examples with references made to the accompanying drawings, wherein:

FIG. 1 is a diagram of a conventional transaction layer packet;

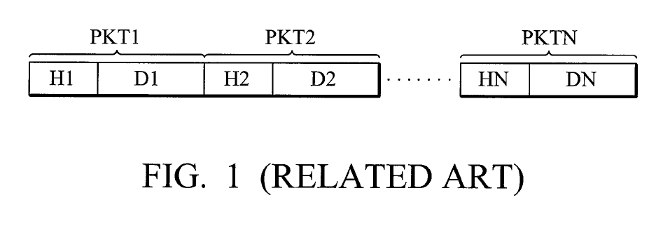

FIG. 2A shows an embodiment of a computer system of the invention;

FIG. 2B shows another embodiment of a computer system of the invention;

FIG. 2C shows another embodiment of a computer system of the invention;

FIG. 3 is a timing chart of a data acquisition method of the invention;

FIG. 4 is a diagram of transaction layer packets of the invention; and

FIG. 5 shows a machine-readable storage medium for data acquisition method in the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

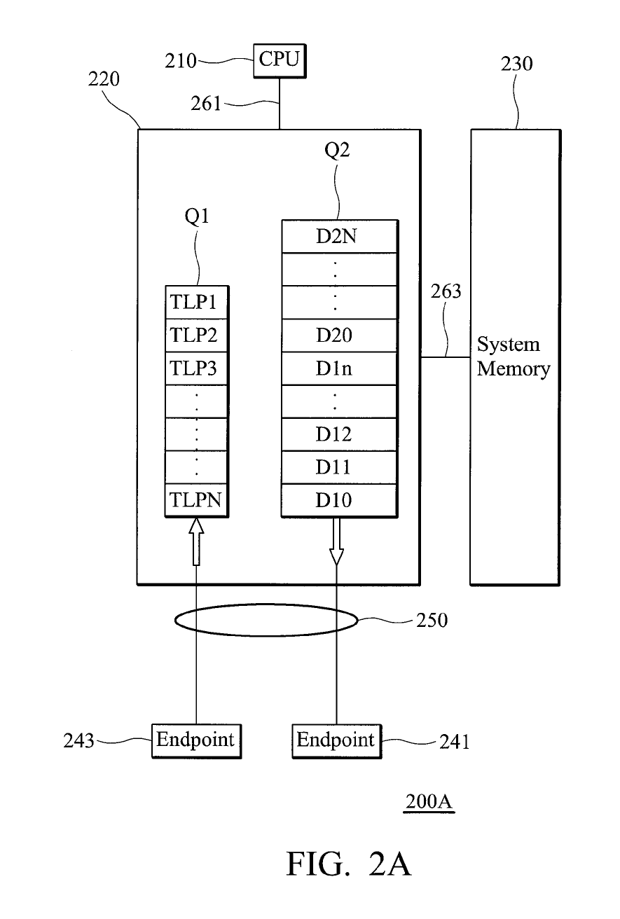

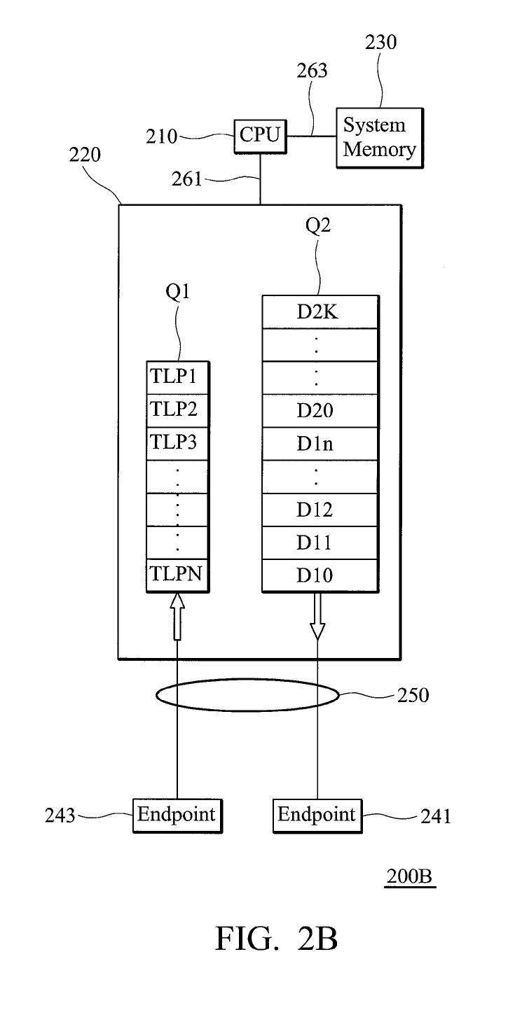

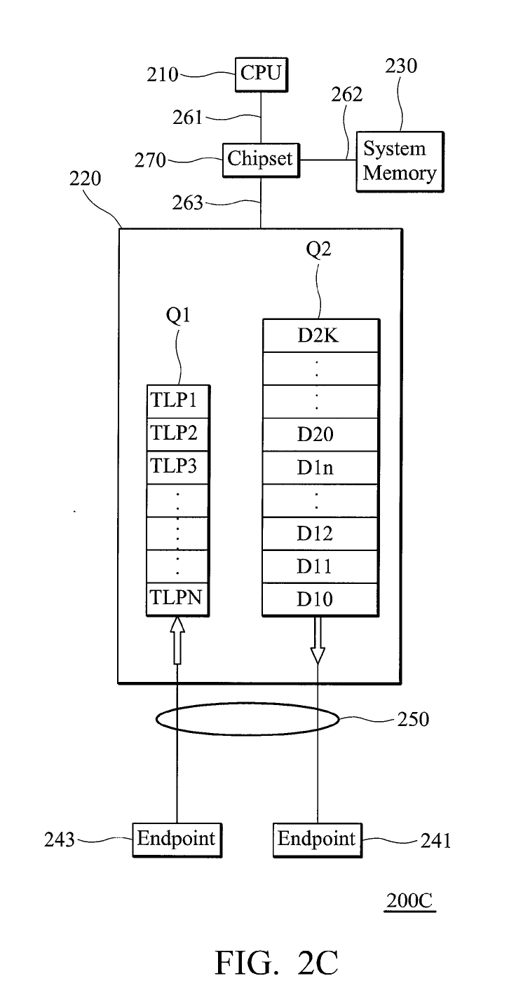

FIG. 2A shows an embodiment of a computer system of the invention. As shown, computer system 200A comprises a central processing unit (CPU) 210, a bridge unit 220, a system memory 230, two endpoints 241 and 243, and a PCI-Express bus 250. The CPU 210 is coupled to the bridge unit 220 through a bus 261, and the system memory 230 is coupled to the bridge unit 220 through a bus 263.

For example, the bridge unit 220 can be a PCI-Express root device, the endpoints 241 and 243 can be PCI-Express peripheral devices, such as I/O devices with Gigabit Ethernet or accelerated graphic port (AGP). In the embodiment, the bridge unit 220 can be a Northbridge, and the system memory 230 can be a dynamic random access memory (DARM), but it is not limited thereto.

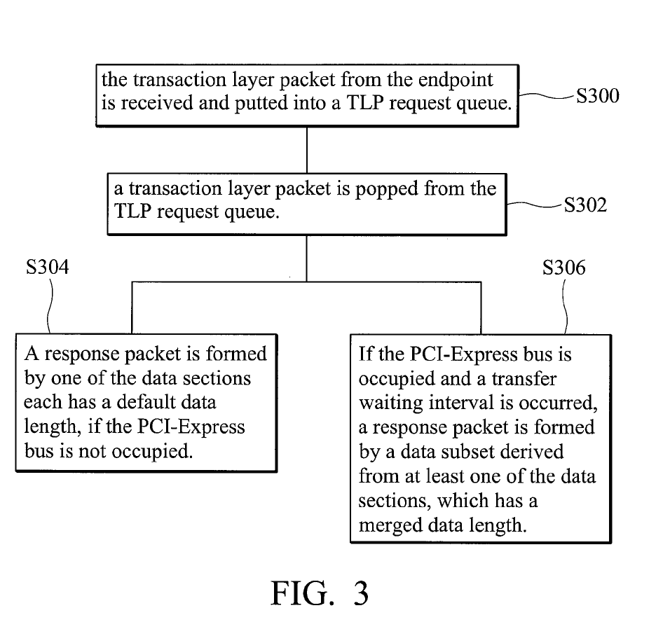

FIG. 3 is a flowchart of a data retrieving method of the invention. In step S300, when the bridge unit 220 receives a transaction layer packet (TLP) from the endpoints 241 or 243, the received transaction layer packet (TLP) is arranged to a TLP request queue Q1. Namely, the bridge unit 220 arranges the transaction layer packet TLP into the TLP request queue Q1 in sequence. Take the TLP1 for example, as shown in FIG. 2A, which is a read request outputting from the endpoint 241.

In step S302, the bridge unit 220 pops a transaction layer packet (ex. the TLP1) from the TLP request queue Q1. In response to the read request of TLP1, the bridge unit 220 generates a plurality of alignment transactions (8 or 4 quad words (QW)) to snoop the CPU 210 to determine a cache hit or a cache miss. When determining a cache hit, data response to the read request is read from a cache of CPU 210; on the contrary, when determining a cache miss, the data response to the read request is read from the system memory 230. Then, data requested by TLP1 is stored into a TLP tracking queue Q2. For example, it is assumed that the packet TLP1 requests a data with 16QW length, the bridge unit 220 may generate a first alignment transaction to retrieve one 8QW data section and a second alignment transaction to retrieve another 8QW data section. Alternately, the bridge unit 220 may generate four alignment transactions to respectively retrieve four 4QW data sections.

Typically, each alignment transaction would snoop the CPU 210 to retrieve a desired data section directly without reading system memory 230 if the desired data section is in cache memory (not shown) of the CPU 210. If not, the alignment transaction then retrieves the desired data section from the system memory 230.

In the invention, according to the read request presented in the TLP1, the bridge unit 220 generates a plurality of alignment transactions to retrieve the requested data with data sections D10˜D1n from the CPU 210 or the system memory 230, and the data sections D10˜D1n are arranged in the TLP tracking queue Q2. Each data sections D10˜D1n of requested data has a default data length, such as 8QW. Similarly, in response to the read request presented in TLP2, the bridge unit 220 further generates a plurality of alignment transactions to retrieve second requested data with data sections D20˜D2N from the CPU 210 or the system memory 230, and the data sections D20˜D2N are also arranged to the TLP tracking queue Q2. Similarly, in response to the read request presented in TLP3˜TLPN, the bridge unit 220 respectively generates a plurality of alignment transactions to retrieve desired data with a plurality of data sections (not shown) from the CPU 210 or the system memory 230 and arranges those data sections in the TLP tracking queue Q2.

To acknowledge the read request, response packets, formed by data sections D10˜D1n, are transferred to the endpoint 241. In order to compliant with the PCI-Express protocol, each data sections should be respectively translated as TLP format before transferring to the endpoint 241. For example, data section D10 is translated as TLP format shown as PTK0 and then PTK0 is outputted to the endpoint 241. Packet PTK0 has both the desired data section D10 and a header HD1 recording information such as record data length, message type, and requestor ID of the PTK0.

In the invention, two conditions are considered as following.

It is assumed that the PCI-Express bus is not occupied, as shown in step S304, a response packet is formed by one of the data sections. For example, PTK0 is formed by the data section D10. In such condition, each response packet is generated from one data section having the default data length defined by PCI-Express protocol; as a result, the header of the response packet records the default data length.

Otherwise, as shown in step S306, it is assumed that the PCI-Express bus is occupied and therefore a transfer waiting interval is occurred. In such condition, a response packet is formed by a data subset, which is derived from at least one of the data sections, with a merged data length. The transfer waiting interval occurs when the PCI-Express bus 250 is occupied by downstream transaction layer packets or data link layer package DLLP, read data return from the CPU 210 is out of order, or the present packet on the PCI-Express bus 250 belongs to a virtual channel which is different from the virtual channel for the first data. For example, the first data many belong to the first virtual channel, but the present packet on the PCI-Express bus 250 does not.

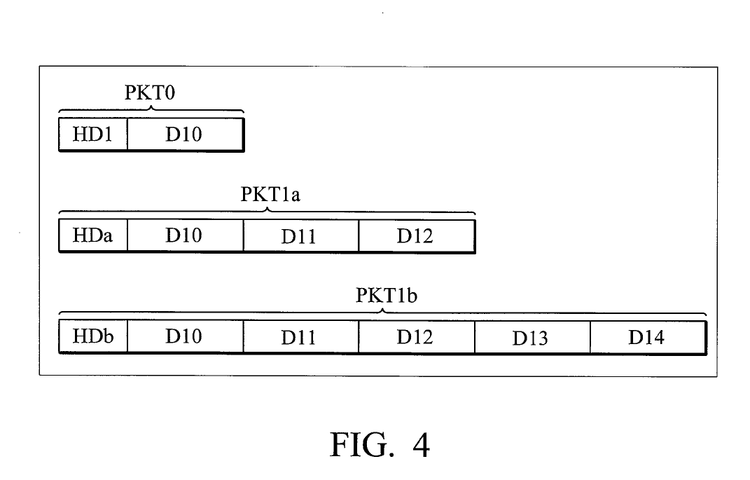

For example, if the PCI-Express bus is occupied, bridge unit 210 packages the data sections D10, D11 and D12 to form a response packet, PKT1a (as shown in FIG. 4); as a result, the data length recorded in the header HDa of PKT1a is the total data length of the data sections D10, D11 and D12. Alternately, the bridge unit 210 packages the data sections D10, D11, D12, D13 and D14 to form another transaction layer packet, PKT1b (as shown in FIG. 4); as a result, the data length recorded in the header HDa of PKT1b is the total data length of the data sections D10, D11, D12, D13 and D14.

The bridge unit 220 executes steps S304 or S306 to generate response packets to the endpoint 241 for acknowledging the read request asserted by the endpoint 243. In the invention, the response packets of different data length are formed from the data sections D10˜D1n according to whether the transfer waiting interval occurs. In the embodiment, one response packet, forming by one data section, with the default data length is formed in step S304; otherwise, another response packet, forming by at least one data section, with a merged data length is formed in step S306.

The data length of the packages PKT1a or PKT1b both exceed the default data length (i.e. the data length of the packet PKT0), but the maximum payload size defined by PCI-Express protocol.

In the embodiment, the bridge unit 220 packages three and five data sections to generate the response packages PKT1a and PKT1b respectively, but it is not limited thereto. The bridge unit 220 can package more data sections to generate the packets PKT1a or PKT1b when total data length of the packet does not exceed the maximum payload size defined by PCI-Express protocol.

In conventional data retrieving method, each data section from CPU or system memory is packaged as a response transaction layer packet (TLP) with a header. However, a response packet in the invention has at least one of data section, as a result, single header is used to include at least one data section, thus preventing redundant headers and improving bus utilization efficiency.

FIG. 2B shows another embodiment of the computer system of the invention. As shown, the computer system 200B is similar to the computer system 200A shown in FIG. 2A, except that the system memory 230 is coupled to the CPU 210 rather than the bridge unit 220, through the bus 263.

The computer system 200B can also execute the data retrieving method of the invention. Namely, the bridge unit 220 packages the data sections requested by one read request to a plurality of transaction layer packages with different data lengths and outputs to the desired endpoint during the PCI-Express bus 250 is occupied by downstream transaction layer packets or data link layer package DLLP, read data return from CPU 210 is out of order, or the present packet on PCI-Express bus 250 belongs to another virtual channel. For simplification, operation and description of the computer system 200B are omitted.

FIG. 2C shows another embodiment of the computer system of the invention. As shown, the computer system 200B is similar to the computer system 200A shown in FIG. 2A, except that the CPU 210 is coupled to the chipset 270, such as Northbridge, through bus 261, system memory 230 is coupled to the chipset 270 through the bus 262 and bridge unit 220 is coupled to the chipset 270 though bus 263. In the embodiment, the chipset 270 can, for example, be a PCI-Express switch. Similarly, the bridge unit 220 packages the data sections requested by one read request to a plurality of transaction layer packages with different data length and outputs to the desired endpoint when the PCI-Express bus 250 is occupied by downstream transaction layer packets or data link layer package DLLP, read data return from the CPU 210 is out of order, or the present packet on the PCI-Express bus 250 belongs to another virtual channel. For simplification, operation and description of the computer system 200C is omitted.

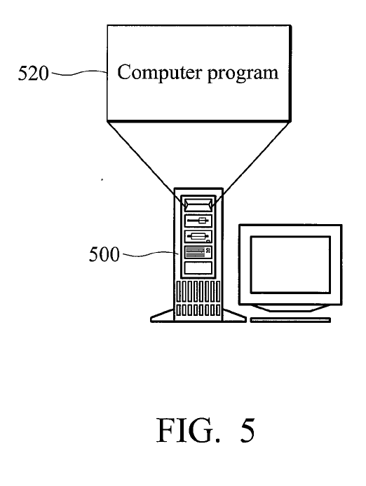

FIG. 5 shows a machine-readable storage medium for data retrieving method in the invention. As shown, the machine-readable storage medium 500 has a computer program 520 to perform the disclosed data retrieving method.

Thus, the data retrieving method of the invention can reduce headers in transactions layer packages to improve data transfer efficient and bus utilization.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data retrieving method for a computer system compliant with PCI-Express protocol, the computer has a PCI-Express bus coupled to at least one endpoint, the method comprising:
retrieving a data in response to a read request from the endpoint, wherein the data is composed by a plurality of data section, wherein data length of each data section is a default data length defined by the PCI-Express specification; and
transferring a plurality of response packets to an objective endpoint, wherein each response packet is formed by the plurality of data sections with a variable data length, wherein each response packet is a TLP with a herder and data content therein.

2. The method as claimed in claim 1, wherein when the PCI-Express bus is not occupied, each response packet is formed by one of the data section with a default data length.

3. The method as claimed in claim 1, wherein when the PCI-Express bus is occupied and a transfer waiting interval is occurred, each response packet is formed by at least one of data sections with a merged data length, wherein the merged data length is the total data length of the data sections.

4. The method as claimed in claim 3, wherein the merged data length exceeds the default data length.

5. The method as claimed in claim 4, wherein the merged data length does not exceed the maximum payload size defined by PCI-Express protocol.

6. The method as claimed in claim 1, further comprising:
generating a plurality of alignment transactions to snoop a CPU to retrieving the data in response to the read request from a cache of the CPU or from a system memory; and
storing the data into a tracking queue.

7. The method as claimed in claim 1, the read request is packaged as a TLP and arranged in a request queue.

8. A machine-readable storage medium with a computer program, which, when executed, causes a computer system to perform a data retrieving method, the computer system compliant with PCI-Express protocol and having a PCI-Express bus coupled to an endpoint, the method comprising:
retrieving a data in response to a read request from the endpoint, wherein the data is composed by a plurality of data section, wherein data length of each data section is a default data length defined by the PCI-Express specification; and
transferring a plurality of response packets to an objective endpoint, wherein each response packet is formed by the plurality of data sections with a variable data length, wherein each response packet is a TLP with a herder and data content therein.

9. The machine-readable storage medium as claimed in claim 8, wherein when the PCI-Express bus is not occupied, each response packet is formed by one of the data section with a default data length.

10. The machine-readable storage medium as claimed in claim 8, wherein when the PCI-Express bus is occupied and a transfer waiting interval is occurred, each response packet is formed by at least one of data sections with a merged data length, wherein the merged data length is the total data length of the data sections.

11. The machine-readable storage medium as claimed in claim 10, wherein the merged data length exceeds the default data length.

12. The machine-readable storage medium as claimed in claim 10, wherein the merged data length does not exceed the maximum payload size defined by PCI-Express protocol.

13. The machine-readable storage medium as claimed in claim 10, wherein the method further comprising:
generating a plurality of alignment transactions to snoop a CPU to retrieving the data in response to the read request from a cache of the CPU or from a system memory; and
storing the data into a tracking queue.

14. The machine-readable storage medium as claimed in claim 8, the read request is packaged as a TLP and arranged in a request queue.

15. A computer system, compliant with PCI-Express protocol, comprising:
a PCI-Express bus;
an endpoint, coupled to the PCI-Express bus; and
a bridge unit coupled to the endpoint through the PCI-Express bus, retrieving a data in response to a read request from the endpoint, wherein the data is composed by a plurality of data section, wherein data length of each data section is a default data length defined by the PCI-Express specification; and transferring a plurality of response packets to an objective endpoint, wherein each response packet is formed by the plurality of data sections with a variable data length, wherein each response packet is a TLP with a herder and data content therein.

16. The computer system as claimed in claim 15, wherein when the PCI-Express bus is not occupied, each response packet is formed by one of the data section with a default data length.

17. The computer system as claimed in claim 15, wherein when the PCI-Express bus is occupied and a transfer waiting interval is occurred, each response packet is formed by at least one of data sections with a merged data length, wherein the merged data length is the total data length of the data sections.

18. The computer system as claimed in claim 17, wherein the merged data length exceeds the default data length.

19. The computer system as claimed in claim 17, wherein the merged data length does not exceed the maximum payload size defined by PCI-Express protocol.

20. The computer system as claimed in claim 15, wherein the bridge unit generates a plurality of alignment transactions to snoop a CPU to retrieving the data in response to the read request from a cache of the CPU or from a system memory; and then stores the data into a tracking queue.

21. The computer system as claimed in claim 15, the read request is packaged as a TLP and arranged in a request queue.

22. The computer system as claimed in claim 15, wherein the bridge unit is coupled to a CPU and a system memory through a first bus and a second bus respectively.

23. The computer system as claimed in claim 15, wherein the bridge unit is coupled to a CPU through a first bus and the CPU is coupled to a system memory through a second bus.

24. The computer system as claimed in claim 15, wherein the bridge unit is a chipset.

25. The computer system as claimed in claim 15, wherein the bridge unit is coupled to a CPU and a system memory through a chipset.

26. The computer system as claimed in claim 25, wherein the bridge unit is a PCI-Express switch.
